(19) United States
(12) Patent Application Publication
(10) Pub. No.: US 2012/0278448 A1
(43) Pub. Date: Nov. 1, 2012

(54) Method and System for Accessing Microblog, and Method and System for Sending Pictures on Microblog Website

(75) Inventors: Zongqing Wang, Shenzhen (CN); Linzhou Zheng, Shenzhen (CN); Qing Wang, Shenzhen (CN); Xiaowen Yao, Shenzhen (CN); Xungeng Li, Shenzhen (CN); Qian Jiang, Shenzhen (CN)

(73) Assignee: TENCENT TECHNOLOGY (SHENZHEN) COMPANY LIMITED, Shenzhen, Guangdong (CN)

(21) Appl. No.: 13/520,580

(22) PCT Filed: Aug. 31, 2011
(86) PCT No.: PCT/CN2011/079206

§ 371 Date: Jul. 5, 2012

(30) Foreign Application Priority Data
Sep. 2, 2010 (CN) 201010273255.7

(51) Int. Cl. G06F 15/16

(52) U.S. Cl. 709/219

(57) ABSTRACT

The present disclosure provides a method and a system for accessing a microblog and a method and a system for sending a picture on a microblog website, and relates to the field of computer technology. The present disclosure includes: prestoring an original picture and a text at a server, and correspondingly storing a thumbnail picture corresponding to the original picture; the server sends the text and the thumbnail picture to the mobile terminal when the mobile terminal sends a request to the server to access the microblog; the server sends the original picture to the mobile terminal when the mobile terminal sends an original picture downloading request to the server to request for obtaining the original picture corresponding to the thumbnail picture. In the embodiments of the present disclosure, a text and a picture are stored separately at a server, and the picture may comprise an original picture and a thumbnail picture. In this way, when a mobile terminal accesses a microblog at the server, the thumbnail picture may be sent to the mobile terminal; and the original picture corresponding to the thumbnail picture is sent to the mobile terminal upon a request from the mobile terminal, so as to reduce the amount of data transmission.

### TECHNICAL FIELD

The present disclosure relates to the field of computer technology, and more particularly, to a method and a system for accessing microblog, and a method and a system for sending a picture on a microblog website.

### BACKGROUND

With the developments of the Internet technologies and the popularity of networks, more and more network users are not simply satisfied with acquiring information via the Internet and the Internet has become a method of communication and exchange between the users. Wherein, besides instant messaging software, microblog emerges as a main way of communication and exchange between users. Microblog is a microblog format that allows users to update and publish short texts timely, and microblog has become an emerging communication way on the Internet because of its flexible forms and timeliness.

Meanwhile, with the development of communication technologies, computer is not the only way to surf on the Internet and more and more people access Microblog via mobile terminals. In the prior art, a mobile terminal can browse the Internet via General Packet Radio Service (GPRS) of 2rd generation mobile communication technology (2G), the 3rd generation mobile telecommunications (3G) or Wireless Fidelity (WiFi).

During the process for implementing the present disclosure, the inventors found that the prior art at least has the following problems:

in the prior art, a microblog will include texts and pictures, the charge will be relatively high to access the Internet via GPRS or the 3G, thus resulting in relatively high usage charge for users if all pictures in the microblog are downloaded.

### SUMMARY

In order to solve the problem in the prior art of relatively high usage charge caused by picture transmission when accessing a microblog via a mobile terminal, the embodiments of the present disclosure provide a method and a system for accessing a microblog, and a method and a system for sending a picture on a microblog website. The technical solutions are as follows.

An embodiment of the present disclosure provides a method for a mobile terminal to access a microblog, the method includes:

an original picture and a text are prestored at a server, and a thumbnail picture corresponding to the original picture is correspondingly stored;

the server sends the text and the thumbnail picture to the mobile terminal when the mobile terminal sends a request to the server to access the microblog;

the server sends the original picture to the mobile terminal when the mobile terminal sends an original picture downloading request to the server to request for obtaining the original picture corresponding to the thumbnail picture.

Preferably, the step that the original picture and the text are prestored at the server, and the thumbnail picture corresponding to the original picture is correspondingly stored may include:

the original picture is obtained, and it is determined that whether the number of bytes of the original picture is larger than a preset threshold, the original picture is zoomed out, when the original picture is larger than the preset threshold, to generate the thumbnail picture whose number of bytes is smaller than the preset threshold; otherwise, the original picture is taken as the thumbnail picture;

the text, the thumbnail picture and the original picture are separately stored, and a corresponding list is generated.

Preferably, the step that the server sends the text and the thumbnail picture to the mobile terminal when the mobile terminal sends the request to the server to access the microblog may include:

when the mobile terminal accesses the microblog, the server sends the text to the mobile terminal;

when the mobile terminal requests for accessing a picture corresponding to the text, the text and its corresponding thumbnail picture are sent to the mobile terminal.

Preferably, the step that the server sends the text and the thumbnail picture to the mobile terminal when the mobile terminal sends the request to the server to access the microblog may include:

when the mobile terminal accesses the microblog, the server sends the text together with the picture to the mobile terminal.

An embodiment of the present disclosure further provides a system for a mobile terminal to access a microblog, the system includes: a server and a mobile terminal; wherein

the server includes:

a storing module, configured to prestore an original picture and a text, and correspondingly store a thumbnail picture corresponding to the original picture;

a receiving module, configured to receive a request sent by the mobile terminal to send the text and the thumbnail picture to the mobile terminal, and further configured to send, when the mobile terminal sends an original picture downloading request to request for obtaining the original picture corresponding to the thumbnail picture, the original picture to the mobile terminal;

the mobile terminal includes:

a request module, configured to send a request to access the microblog to the server, and receive the text and the thumbnail picture sent by the server, and further configured to send an original picture downloading request to the sever to request for obtaining the original picture corresponding to the thumbnail picture and receive the original picture.

Preferably, the storing module may include:

an obtaining unit, configured to obtain the original picture, and determine whether or not the number of bytes of the original picture is larger than a preset threshold, zoom out the original picture, when the number of bytes of the original picture is larger than the preset threshold, to generate the thumbnail picture whose number of bytes is smaller than the preset threshold; otherwise, take the original picture as the thumbnail picture;

a corresponding unit, configured to separately store the text, the thumbnail picture and the original picture, and generate a corresponding list.

Preferably, the receiving module may include:

a first receiving unit, configured to send, when the mobile terminal accesses the microblog, the text to the mobile terminal;

a second receiving unit, configured to send, when the mobile terminal requests for accessing the picture corresponding to the text, the thumbnail picture corresponding to the text to the mobile terminal;

a third receiving unit, configured to send, when the mobile terminal requests for the original picture, the original picture corresponding to the thumbnail picture to the mobile terminal.

Preferably, the receiving module may include:

a fourth receiving unit, configured to send, when the mobile terminal accesses the microblog, the text together with the picture to the mobile terminal.

An embodiment of the present disclosure further provides a method for sending a picture on a microblog website, the method includes:

an original picture and a text is prestored, and a thumbnail picture corresponding to the original picture is correspondingly stored;

the text and the thumbnail picture are sent to a mobile terminal when a request to access the microblog from the mobile terminal is received;

the original picture corresponding to the thumbnail picture is sent to the mobile terminal when an original picture downloading request sent by the mobile terminal according to the thumbnail picture is received.

Preferably, the step that the original picture and the text is prestored and the thumbnail picture corresponding to the original picture is correspondingly stored may include:

the original picture is obtained, and whether or not the number of bytes of the original picture is larger than a preset threshold is determined, the original picture is zoomed out, when the number of bytes of the original picture is larger than the preset threshold, to generate the thumbnail picture whose number of bytes is smaller than the preset threshold; otherwise, then the original picture is taken as the thumbnail picture;

the text, the thumbnail picture and the original picture are separately stored, and a corresponding list is generated.

Preferably, the step that the text and the thumbnail picture are sent to the mobile terminal when the request to access the microblog from the mobile terminal is received may include:

the text is sent to the mobile terminal when the request to access the microblog from the mobile terminal is received;

the thumbnail picture corresponding to the text is sent to the mobile terminal when a request for obtaining the picture corresponding to the text is received from the mobile terminal.

Preferably, the step that the text and the thumbnail picture are sent to the mobile terminal when the request to access the microblog from the mobile terminal is received may include:

when the mobile terminal accesses the microblog, the text together with the picture are sent to the mobile terminal.

An embodiment of the present disclosure further provides a system for sending a picture on a microblog website, the system includes:

a storing module, configured to prestore an original picture and a text, and correspondingly store a thumbnail picture corresponding to the original picture;

a receiving module, configured to receive a request sent by a mobile terminal to send the text and the thumbnail picture to the mobile terminal, and further configured to send, when the mobile terminal sends an original picture downloading request to request for obtaining the original picture corresponding to the thumbnail picture, the original picture to the mobile terminal.

Preferably, the storing module may include:

an obtaining unit, configured to obtain the original picture, and determine whether or not the number of bytes of the original picture is larger than a preset threshold, zoom out the original picture, when the number of bytes of the original picture is larger than the preset threshold, to generate the thumbnail picture whose number of bytes is smaller than the preset threshold; otherwise, take the original picture as the thumbnail picture;

a corresponding unit, configured to separately store the text, the thumbnail picture and the original picture, and generate a corresponding list.

Preferably, the receiving module may includes:

a first receiving unit, configured to send, when the mobile terminal accesses the microblog, the text to the mobile terminal;

a second receiving unit, configured to send, when the mobile terminal requests for accessing the picture corresponding to the text, the thumbnail picture corresponding to the text to the mobile terminal;

a third receiving unit configured to send, when the mobile terminal requests for the original picture, the original picture corresponding to the thumbnail picture to the mobile terminal.

Preferably, the receiving module may include:

a fourth receiving module, configured to send, when the mobile terminal accesses the microblog, the text together with the picture to the mobile terminal.

The technical solutions provided by the embodiments of the present disclosure have the following beneficial effects: in the embodiments of the present disclosure, a text and a picture are stored separately at a server, and the picture may comprise an original picture and a thumbnail picture. In this way, when a mobile terminal accesses a microblog at the server, the thumbnail picture may be sent to the mobile terminal; and the original picture corresponding to the thumbnail picture is sent to the mobile terminal upon a request from the mobile terminal, so as to reduce the amount of data transmission.

### BRIEF DESCRIPTION OF THE DRAWINGS

FIG. 1 is a flowchart diagram of the first embodiment of the present disclosure;

FIG. 2 is a flowchart diagram of the second embodiment of the present disclosure;

FIG. 3 is a flowchart diagram of the third embodiment of the present disclosure;

FIG. 4 is a flowchart diagram of the fourth embodiment of the present disclosure;

FIG. 5 is a flowchart diagram of the fifth embodiment of the present disclosure;

FIG. 6 is a flowchart diagram of the sixth embodiment of the present disclosure;

FIG. 7 is a flowchart diagram of the seventh embodiment of the present disclosure;

FIG. 8 is a flowchart diagram of the eighth embodiment of the present disclosure.

### DETAILED DESCRIPTION

To make the objectives, technical solutions and advantages of the present disclosure clearer, the embodiments of the present disclosure will be further described hereinbelow in details with reference to the drawings.

The design idea of the embodiments of the present disclosure lies in that: separately storing a text and a picture in a server, and the picture may comprise an original picture and a thumbnail picture. In this way, when a mobile terminal accesses a microblog at the server, the thumbnail picture may be sent to the mobile terminal; and the original picture corresponding to the thumbnail picture is sent to the mobile terminal upon a request from the mobile terminal, so as to reduce the amount of data transmission. The present disclosure will be further described hereinbelow through embodiments.

### Embodiment 1

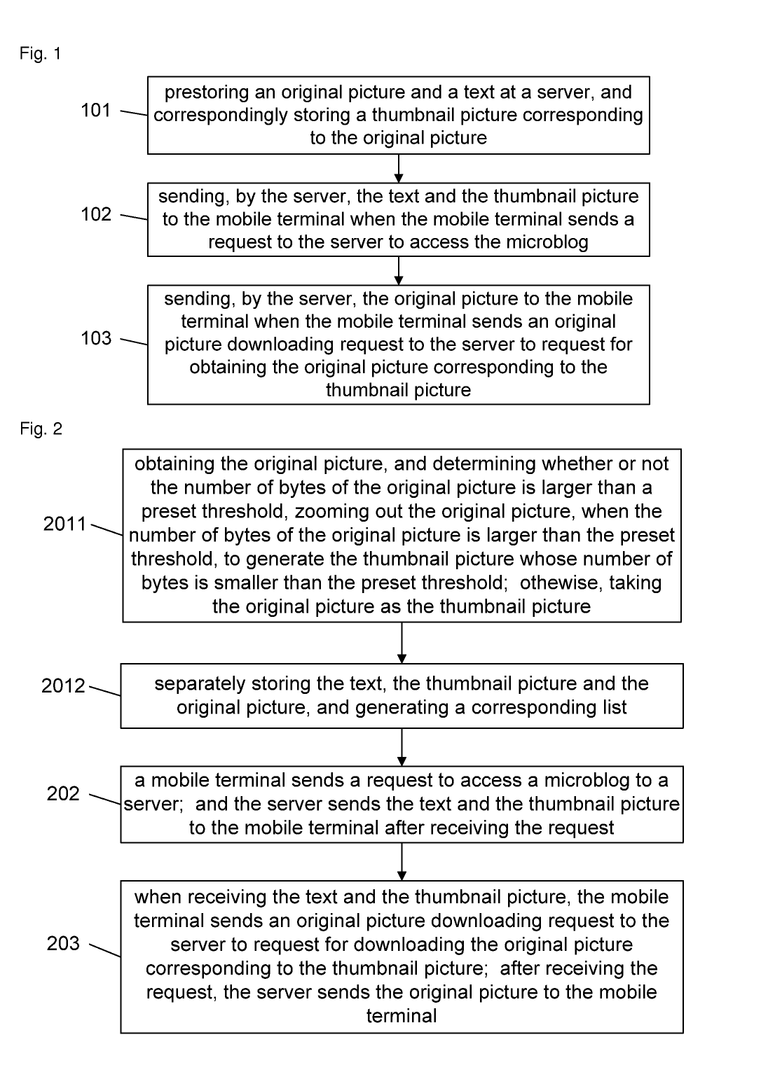

The first embodiment of the present disclosure provides a method for a mobile terminal to access a microblog, and the process of the method is shown in FIG. 1, which includes:

Step 101: an original picture and a text are prestored in a server, and a thumbnail picture corresponding to the original picture is correspondingly stored;

Step 102: when a mobile terminal sends a request to the server to access a microblog, the server sends the text and the thumbnail picture to the mobile terminal;

Step 103: when the mobile terminal sends to the server an original picture downloading request to request for obtaining the original picture corresponding to the thumbnail picture, the server sends the original picture to the mobile terminal.

In this embodiment of the present disclosure, a text and a picture are stored separately in a server. When a mobile terminal accesses a microblog, the picture is not sent to the mobile terminal. A text and a corresponding thumbnail picture are sent to the mobile terminal only when the mobile terminal requests for reading the text. Further, the original picture corresponding to the thumbnail picture is sent to the mobile terminal only when the user is interested in the thumbnail picture. In the prior art, the original picture is directly set on the homepage of the microblog, and the text and the original picture on the homepage are directly send to the mobile terminal when the mobile terminal accesses the microblog. Compared with the prior art, the method of this embodiment of the present disclosure can reduce the data flow when a mobile terminal accesses a microblog and save cost. Meanwhile, a user can find the original picture which the user is interested in via a thumbnail picture without influencing user usage.

### Embodiment 2

The second embodiment of the present disclosure provides a method for a mobile terminal to access a microblog, which is improved on the basis of the first embodiment. The process of this method is shown in FIG. 2 and includes:

Step 201: an original picture and a text are prestored in a server, and a thumbnail picture corresponding to the original picture is correspondingly stored. Generally, a text which is not longer than 140 characters can be included in a microblog. To be more expressive, a picture which is known as an original picture can be added in an article. Then, Step 201 may specifically include:

Step 2011: the original picture is obtained, and whether or not the number of bytes of the original picture is larger than a preset threshold is determined; the original picture is zoomed out, when the number of bytes of the original picture is larger than the preset threshold, to generate a thumbnail picture whose number of bytes is smaller than the preset threshold; if no, the original picture is taken as the thumbnail picture;

Step 2012: the text, the thumbnail picture and the original picture are separately stored, and a corresponding list is generated.

“Separately storing” refers to: the text and the original picture are separately stored, and the original picture is sent to a mobile terminal upon a request from a user. In this way, the data flow can be reduced when a user accesses a microblog, and a thumbnail picture can be included to improve user experience. The thumbnail picture can be embedded in the text, and in this case, the thumbnail picture can be sent to the mobile terminal by means of the method of Step 102. Also, the thumbnail picture and the text can also be separately stored, and sent to the mobile terminal by means of the method of Step 202-203 as described hereinbelow.

Step 202: the mobile terminal sends a request to access the microblog to the server; and the server sends the text and the thumbnail picture to the mobile terminal after receiving the request.

In an embodiment of the present disclosure, the text and the picture of the microblog can be sent to the mobile terminal together, i.e. determining, according to the corresponding list, whether or not there is a thumbnail picture corresponding to the text; if yes, then sending the text and the picture of the microblog to the mobile terminal together; if no, only the text is sent.

In another embodiment of the present disclosure, the text of the microblog may be sent to the mobile terminal. Determining whether or not there is a thumbnail picture corresponding to the text upon a request from the mobile terminal, if yes, then sending the thumbnail picture the mobile terminal; if no, then a prompting message is returned. In this way, the corresponding thumbnail picture will be sent to the mobile terminal only when a user is interested in the text, thus the amount of data transmission can be reduced during user browsing process.

Step 203: when receiving the text and the thumbnail picture, the mobile terminal sends an original picture downloading request to the server to request for downloading the original picture corresponding to the thumbnail picture; after receiving the request, the server sends the original picture to the mobile terminal. When receiving the thumbnail picture and the text, if the user is interested in the text and the thumbnail picture, the user can select the thumbnail picture by clicking etc., and send the original picture downloading request to the server.

Further, when the server receives the original picture downloading request, the server determines whether or not there is a corresponding original picture, and if yes, then the server sends the original picture to the mobile terminal, and if no, then the server returns a prompting message.

Wherein in Step 202, the text can be sent first, and then the thumbnail picture is sent upon a request from the mobile terminal; the text and the thumbnail picture can be sent together to the mobile terminal directly. It is not limited by this embodiment of the present disclosure.

In the method above, a picture downloading policy of the mobile terminal may also be determined by presetting rules in the mobile terminal. In other words, the method may further include:

Step a: a manner that the mobile terminal accesses the Internet is obtained, i.e. whether the mobile terminal accesses the Internet via a mobile network connection (e.g. GPRS connection or 3G connection) or via a wireless network connection (e.g. WiFi connection). If the mobile terminal accesses the Internet via a mobile network connection, then go to Step b; If the mobile terminal accesses the Internet via a wireless network connection, then the step ends.

Since communication cost of a mobile network can be avoided when the mobile terminal accesses the Internet using a wireless network connection, different policies can be set for the mobile network connection and the wireless network connection, respectively.

Step b: the built-in rules of the mobile terminal is read to determine a downloading plicy for the original picture and the thumbnail picture when accessing the microblog. The built-in rules may be:

Policy 1: when the mobile terminal accesses the microblog, only the text is downloaded. The thumbnail picture is downloaded upon a request of a user, and the original picture is downloaded upon a second request of the user;

Policy 2: when the mobile terminal accesses the microblog, a text and a thumbnail corresponding to each text are downloaded, and the original picture is downloaded upon a request of a user.

Policy 3: when the mobile terminal accesses the microblog, the original picture is downloaded directly.

Therefore, in Step b, when the mobile terminal is set to Policy 1, then directly go to Step 203; when the mobile terminal is set to Policy 2, then the text and the thumbnail corresponding to each text are downloaded first, and then the original picture is downloaded upon a request from a user; when the mobile terminal is set to Policy 3, the method in the prior art can be used directly, i.e. the text together with the corresponding original picture is downloaded to the mobile terminal directly.

Further, this embodiment of the present disclosure may further include:

Step A: when the mobile terminal accesses the Internet via a mobile network connection, if the user hasn't downloaded the original picture or the thumbnail picture, the mobile terminal will not download the original picture or the thumbnail picture via a wireless network when the mobile user switches to access the Internet via the wireless network. The original picture and/or the thumbnail picture will be downloaded only when the user accesses the text again.

In this embodiment of the present disclosure, the text corresponds to the thumbnail picture and the original picture by means of the corresponding list, which facilitates indexing and modification and can save system overhead during the searching process. Meanwhile, different built-in rules can be preset to determine a downloading policy of the original picture and the thumbnail picture when accessing the microblog, thus users can define downloading policies according to the cost of network access.

### Embodiment 3

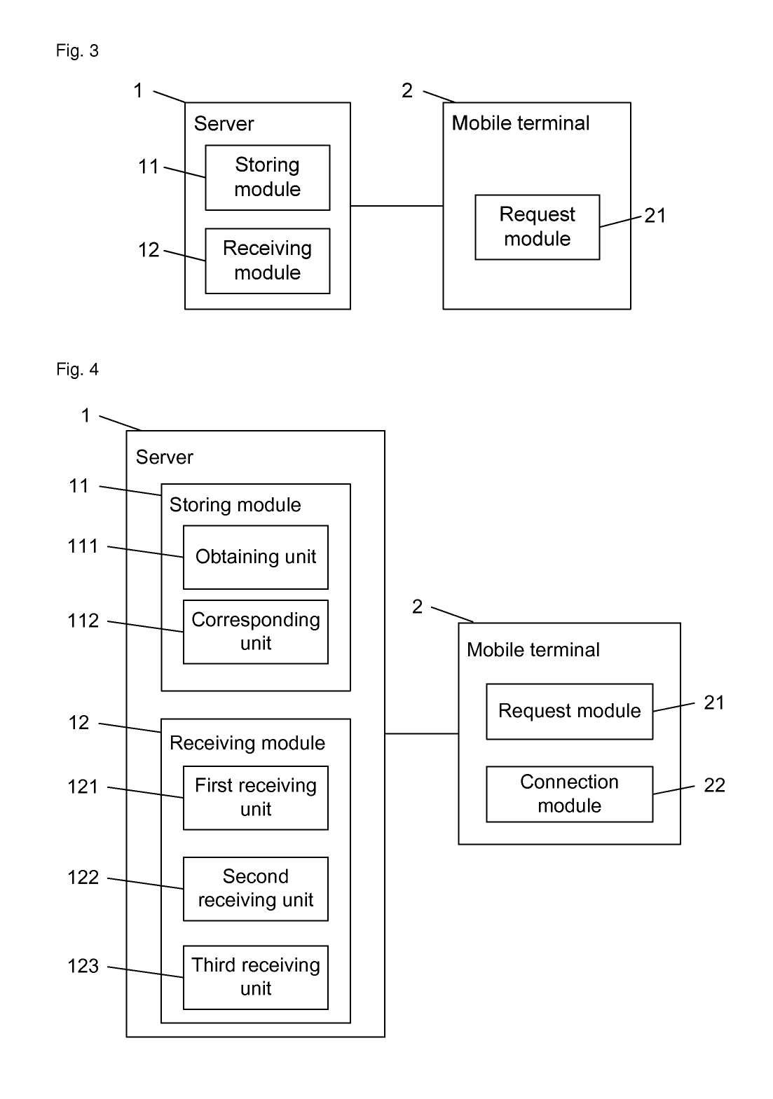

The third embodiment of the present disclosure provides a system for a mobile terminal to access a microblog and its structures are shown in FIG. 3, which includes a server 1 and a mobile terminal 2;

the server 1 includes:

a storing module 11, configured to prestore an original picture and a text, and correspondingly store a thumbnail picture corresponding to the original picture;

a receiving module 12, configured to receive a request sent by the mobile terminal 2 to send the text and the thumbnail picture to the mobile terminal 2; and further configured to send, when the mobile terminal 2 sends an original picture downloading request to request for obtaining the original picture corresponding to the thumbnail picture, the original picture to the mobile terminal 2.

The mobile terminal 2 includes:

a request module 21, configured to send a request to access a microblog to the server 1, and receive the text and the thumbnail picture sent by the server 1; and further configured to receive, when sending the original picture downloading request to the sever 1 to request for obtaining the original picture corresponding to the thumbnail picture, the original picture sent by the server 1.

In this embodiment of the present disclosure, a text and a picture are stored separately in a server, when a mobile terminal accesses a microblog, the picture is not sent to the mobile terminal. A text and a corresponding thumbnail picture are sent to the mobile terminal only when the mobile terminal requests to reads a text therein. Further, the original picture corresponding to the thumbnail picture is sent to the mobile terminal only when a user is interested in the thumbnail picture. In the prior art, the original picture is directly set on the homepage of the microblog, and the text and the original picture on the homepage are sent together to the mobile terminal directly when the mobile terminal accesses the microblog. Compared with the prior art, the method of this embodiment of the present disclosure can reduce the data flow when a mobile terminal accesses a microblog, thereby the cost is saved. Meanwhile, a user can find the original picture which the user is interested in via the thumbnail picture without influencing user usage.

### Embodiment 4

The fourth embodiment of the present invention provides a system for a mobile terminal to access a microblog, which is improved on the basis of the third embodiment, the structures of this system are shown in FIG. 4, which includes: a server 1 and a terminal 2; the server 1 includes:

a storing module 11, configured to prestore an original picture and a text in a server 1, and correspondingly store a thumbnail picture corresponding to the original picture. Generally, a text which is not longer than 140 characters can be included in a microblog. To be more expressive, a picture which is known as an original picture can be added in an article. The storing module 11 may specifically include:

an obtaining unit 111, configured to obtain the original picture, and determine whether or not the number of bytes of the original picture is larger than a preset threshold; zoom out the original picture, when the number of bytes of the original picture is larger than the preset threshold, to generate a thumbnail picture whose number of bytes is smaller than the preset threshold; otherwise, take the original picture as the thumbnail picture;

a corresponding unit 112, configured to separately store the text, the thumbnail picture and the original picture, and generate a corresponding list.

“Separately store” refers to: store the text and the original picture separately, and send the original picture to the mobile terminal 2 upon a request from a user. In this way, the data flow can be reduced when the user accesses a microblog, and the thumbnail picture can be included to improve user experience. The thumbnail picture can be embedded in the text, and in this case, the thumbnail picture can be sent to the mobile terminal 2 by means of the method of the receiving module 12 in the aforementioned third embodiment. Also, the thumbnail picture and the text can also be separately stored, and sent to the mobile terminal 2 by means of the first receiving unit 121 and the second receiving unit 122 as described hereinbelow.

a receiving module 12, configured to receive a request sent by the mobile terminal 2 to send the text and the thumbnail picture to the mobile terminal 2; and further configured to send, when the mobile terminal 2 sends an original picture downloading request to request for obtaining the original picture corresponding to the thumbnail picture, the original picture to the mobile terminal 2.

In an embodiment of the present disclosure, the receiving module 12 may send the text of the microblog to the mobile terminal 2. Meanwhile, determining, according to the corresponding list, whether or not there is a thumbnail picture corresponding to the text, if yes, then sending the thumbnail picture together to the mobile terminal 2, i.e. the receiving module 12 may specifically include:

a fourth receiving unit configured to send, when a mobile terminal accesses a microblog, the text and the picture to the mobile terminal 2 together.

In another embodiment of the present disclosure, the receiving module 12 may further send the text of the microblog to the mobile terminal 2. Whether there is a thumbnail picture corresponding to the text is determined upon a request of the mobile terminal 2, if yes, then the thumbnail picture is sent to the mobile terminal 2, if no, then a prompting message is returned. In this way, the corresponding thumbnail picture is sent to the mobile terminal 2 only when a user is interested in the text, thereby reducing the amount of data transmission during user browsing process, i.e. the receiving module 12 may specifically include:

a first receiving unit 121 configured to send, when the mobile terminal 2 accesses a microblog, the text to the mobile terminal 2;

a second receiving unit 122 configured to send, when the mobile terminal 2 requests for accessing the picture corresponding to the text, the thumbnail picture corresponding to the text to the mobile terminal 2;

a third receiving unit 123 configured to send, when the mobile terminal 2 requests for the original picture, the original picture corresponding to the thumbnail picture to the mobile terminal 2.

The mobile terminal 2 includes:

a connection module 22 configured to connect to the server 1, the connection mode may be a mobile network connection (e.g. GPRS connection or 3G connection) or a wireless network connection (e.g. WiFi connection).

a request module 21, configured to send a request to access the microblog to the server 1, and receive the text and the thumbnail picture sent by the server 1; and further configured receive, when sending an original picture downloading request to the sever 1 to request for obtaining the original picture corresponding to the thumbnail picture, the original picture sent by the server 1.

In the system above, a picture downloading policy of the mobile terminal 2 may also be determined by presetting rules in the mobile terminal 2, i.e. the mobile terminal 2 may further include:

a mode obtaining module, configured to obtain an Internet access mode of the mobile terminal 2, i.e. whether the mobile terminal 2 accesses the Internet via a mobile network connection (e.g. GPRS connection or 3G connection) or via a wireless network connection (e.g. WiFi connection); and read the built-in rules of the mobile terminal 2 to determine a downloading policy of the original picture and the thumbnail picture when accessing the microblog.

Since communication cost of a mobile network can be avoided when the mobile terminal 2 accesses the Internet using a wireless network connection, different policies can be set for the mobile network connection and the wireless network connection, respectively. Therefore, in an embodiment of the present disclosure, the built-in rules may be:

Policy 1: when the mobile terminal 2 accesses the microblog, only the text is downloaded. The thumbnail picture is downloaded upon a request of a user, and the original picture is downloaded upon a second request of the user;

Policy 2: when the mobile terminal 2 accesses the microblog, a text and a thumbnail corresponding to each text are downloaded, and the original picture is downloaded upon a request of a user.

Policy 3: when the mobile terminal 2 accesses the microblog, the original picture is downloaded directly.

Further, the policies of this embodiment of the present disclosure may further include:

When the mobile terminal accesses the Internet via a mobile network connection, if the user hasn't downloaded the original picture or the thumbnail picture, the mobile terminal will not download the original picture or the thumbnail picture via a wireless network when the mobile user switches to access the Internet via the wireless network. The original picture and/or the thumbnail picture will be downloaded only when the user accesses the text again.

In this embodiment of the present disclosure, the text corresponds to the thumbnail picture and the original picture by means of the corresponding list, which facilitates indexing and modification and can save system overhead during the searching process. Meanwhile, different built-in rules can be preset to determine a downloading policy of the original picture and the thumbnail picture when accessing the microblog, thus users can define downloading policies according to the cost of network access.

The concepts and principles of the systems in the third and fourth embodiments of the present disclosure are the same as those in the aforementioned first and second embodiments. Therefore, the parts which are the same as the first and second embodiments will not be repeated in the third and fourth embodiments.

### Embodiment 5

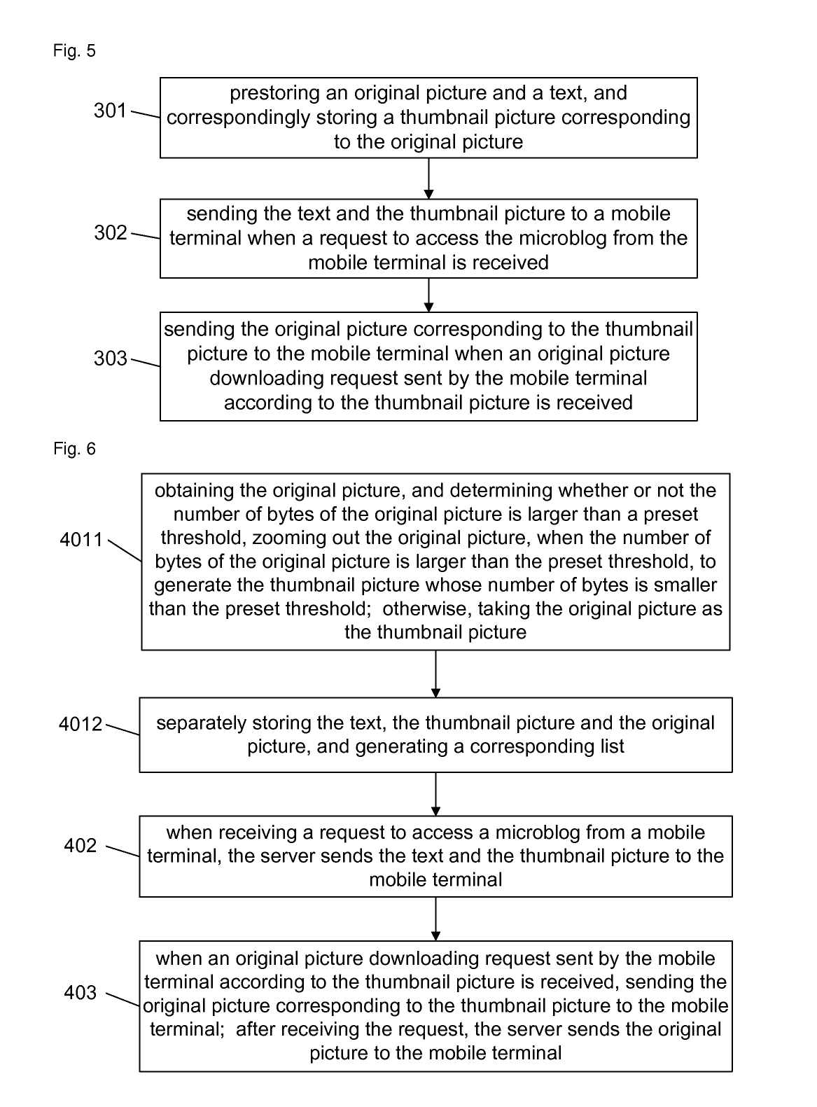

The fifth embodiment of the present disclosure provides a method for sending a picture on a microblog website, and the process of the method is shown in FIG. 5, which includes:

Step 301: an original picture and a text are prestored, and a thumbnail picture corresponding to the original picture is correspondingly stored;

Step 302: when a request to access a microblog from a mobile terminal is received, the text and the thumbnail picture are sent to the mobile terminal;

Step 303: when an original picture downloading request sent by the mobile terminal according to the thumbnail picture is received, the original picture corresponding to the thumbnail picture is sent to the mobile terminal.

In this embodiment of the present disclosure, the microblog website stores the text, the thumbnail picture and the original picture separately. When the mobile terminal accesses the microblog, only the homepage is sent to the mobile terminal. Only when the mobile terminal requests to read a text therein, the text and the corresponding thumbnail picture are sent to the mobile terminal. Further, the original picture corresponding to the thumbnail picture is sent to the mobile terminal only when the user is interested in the thumbnail picture. In the prior art, the original picture is set on the homepage of the microblog directly, and the text and the original picture on the homepage are sent together to the mobile terminal directly when the mobile terminal accesses the microblog. Compared with the prior art, the method of this embodiment of the present disclosure can reduce the data flow when a mobile terminal accesses a microblog, thereby the cost is saved. Meanwhile, a user can find the original picture which the user is interested in via the thumbnail picture without influencing user usage.

### Embodiment 6

The sixth embodiment of the present invention provides a method for sending a picture on a microblog website, which is improved on the basis of the fifth embodiment, and the process of the method is shown in FIG. 6, which includes:

Step 401: an original picture and a text are prestored on a server, and correspondingly a thumbnail picture corresponding to the original picture is stored. Generally, a text which is not longer than 140 characters can be included in a microblog. To be more expressive, a picture which is known as an original picture can be added in an article. Then, Step 401 may specifically include:

Step 4011: the original picture is obtained, and whether or not the number of bytes of the original picture is larger than a preset threshold is determined; the original picture is zoomed out, when the number of bytes of the original picture is larger than the preset threshold, to generate a thumbnail picture whose number of bytes is smaller than the preset threshold; otherwise, the original picture is taken as the thumbnail picture;

Step 4012: the text, the thumbnail picture and the original picture are separately stored, and a corresponding list is generated.

“Separately storing” refers to: the text and the original picture are separately stored, and the original picture is sent to a mobile terminal upon a request from a user. In this way, the data flow can be reduced when the user accesses a microblog, and a thumbnail picture can be included to improve user experience. The thumbnail picture can be embedded in the text, and in this case, the thumbnail picture can be sent to the mobile terminal by means of the method of Step 302. Also, the thumbnail picture and the text can also be separately stored, and sent to the mobile terminal by means of the methods of Step 402-403 as described hereinbelow.

Step 402: when receiving a request to access the microblog from the mobile terminal, the server sends the text and the thumbnail picture to the mobile terminal.

In an embodiment of the present disclosure, the text and the picture of the microblog can be sent to the mobile terminal together, i.e. determining, according to the corresponding list, whether or not there is a thumbnail picture corresponding to the text; if yes, then sending the text and the picture of the microblog to the mobile terminal together; if no, only the text is sent.

In another embodiment of the present disclosure, the text of the microblog may be sent to the mobile terminal. Determining whether or not there is a thumbnail picture corresponding to the text upon a request from the mobile terminal; if yes, then sending the thumbnail picture to the mobile terminal; if no, then a prompting message is returned. In this way, the corresponding thumbnail picture will be sent to the mobile terminal only when a user is interested in the text, thus the amount of data transmission can be reduced during user browsing process.

Step 403: when an original picture downloading request sent by the mobile terminal according to the thumbnail picture is received, sending the original picture corresponding to the thumbnail picture to the mobile terminal; after receiving the request, the server sends the original picture to the mobile terminal.

In this step, when a user receives the thumbnail picture of Step 402, if the user is interested in the text and the thumbnail picture, then the user can select the thumbnail picture by clicking etc., and send an original picture downloading request to the server.

Further, when the server receives the original picture downloading request, the server determines whether or not there is a corresponding original picture, and if yes, then the server sends the original picture to the mobile terminal, if no, then the server returns a prompting message.

Wherein in Step 402, the text can be sent first, and then the thumbnail picture is sent upon a request from the mobile terminal; the text and the thumbnail picture can be sent together to the mobile terminal directly. It is not limited by this embodiment of the present disclosure.

In this embodiment of the present disclosure, the text corresponds to the thumbnail picture and the original picture through the corresponding list, which facilitates indexing and modification and can save system overhead during the searching process. Meanwhile, different built-in rules can be preset to determine a downloading policy of the original picture and the thumbnail picture when accessing the microblog, thus users can define downloading policies according to the cost of network access.

### Embodiment 7

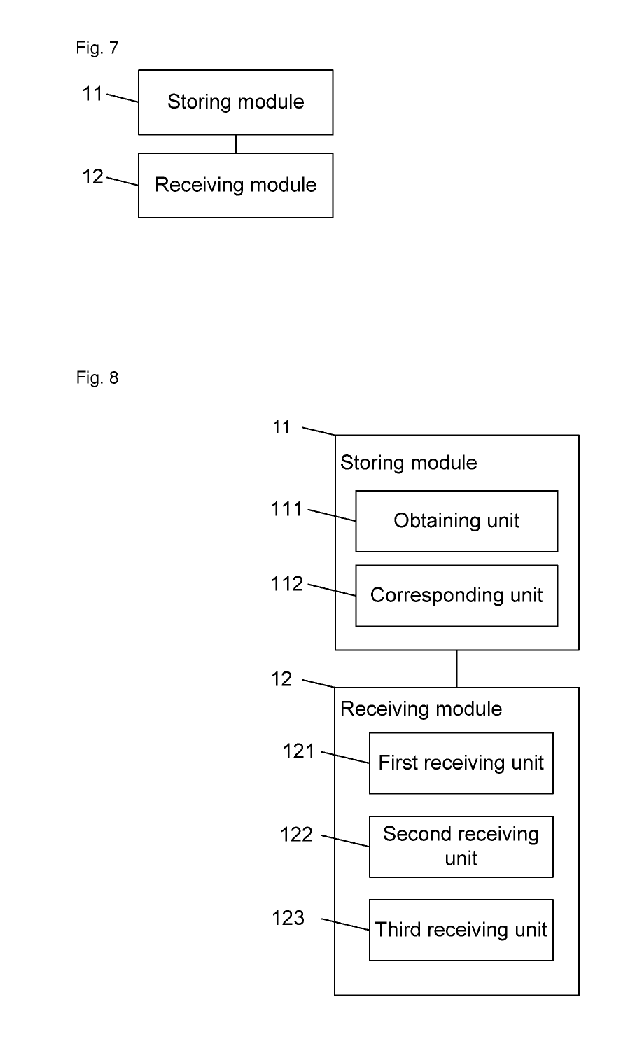

The seventh embodiment of the present disclosure provides a system for sending a picture on a microblog website, and its structures are shown in FIG. 7, which includes:

a storing module 11, configured to prestore an original picture and a text, and correspondingly store a thumbnail picture corresponding to the original picture;

a receiving module 12, configured to receive a request sent by a mobile terminal to send the text and the thumbnail picture to the mobile terminal; and further configured to send, when the mobile terminal sends an original picture downloading request to request for obtaining the original picture corresponding to the thumbnail picture, the original picture to the mobile terminal.

In this embodiment of the present disclosure, a text and a picture are stored separately in a server, when a mobile terminal accesses a microblog, the picture is not sent to the mobile terminal. A text and a corresponding thumbnail picture are sent to the mobile terminal only when the mobile terminal requests to read a text therein. Further, the original picture corresponding to the thumbnail picture is sent to the mobile terminal only when a user is interested in the thumbnail picture. In the prior art, the original picture is directly set on the homepage of the microblog, and the text and the original picture on the homepage are sent together to the mobile terminal directly when the mobile terminal accesses the microblog. Compared with the prior art, the method of this embodiment of the present disclosure is able to reduce the data flow when a mobile terminal accesses a microblog, thereby the cost is saved. Meanwhile, a user can find the original picture which the user is interested in via the thumbnail picture without influencing user usage.

### Embodiment 8

The eighth embodiment of the present disclosure provides a system for sending a picture on a microblog website, which is improved on the basis of the seventh embodiment, the structures of this system are shown in FIG. 8, which includes:

a storing module 11, configured to prestore an original picture and a text in a server, and correspondingly store a thumbnail picture corresponding to the original picture. Generally, a text which is not longer than 140 characters can be included in a microblog. To be more expressive, a picture which is known as an original picture can be added in an article. The storing module 11 may specifically include:

an obtaining unit 111, configured to obtain the original picture, and determine whether or not the number of bytes of the original picture is larger than a preset threshold; zoom out the original picture, when the number of bytes of the original picture is larger than the preset threshold, to generate a thumbnail picture whose number of bytes is smaller than the preset threshold; otherwise, take the original picture as the thumbnail picture;

a corresponding unit 112, configured to separately store the text, the thumbnail picture and the original picture, and generate a corresponding list;

“Separately store” refers to: store the text and the original picture separately, and send the original picture to the mobile terminal upon a request from a user. In this way, the data flow can be reduced when the user accesses a microblog, and the thumbnail picture can be included to improve user experience. The thumbnail picture can be embedded in the text, and in this case, the thumbnail picture can be sent to the mobile terminal by means of the method of the receiving module 12 in the seventh embodiment. Also, the thumbnail and the text can also be separately stored, and sent to the mobile terminal by means of the first 121 receiving unit and the second receiving unit 122 as described hereinbelow;

a receiving module 12, configured to receive a request sent by the mobile terminal to send the text and the thumbnail picture to the mobile terminal; and further configured to send, when the mobile terminal sends an original picture downloading request to request to request for obtaining the original picture corresponding to the thumbnail picture, the original picture to the mobile terminal.

In an embodiment of the present disclosure, the receiving module 12 may send the text of the microblog to the mobile terminal. Meanwhile, determining, according to the corresponding list, whether or not there is a thumbnail picture corresponding to the text, if yes, then sending the thumbnail picture together to the mobile terminal, i.e. the receiving module 12 may specifically include:

a fourth receiving unit configured to send, when a mobile terminal accesses a microblog, the text and the picture to the mobile terminal together.

In another embodiment of the present disclosure, the receiving module 12 may further send the text of the microblog to the mobile terminal. Whether there is a thumbnail picture corresponding to the text is determined upon a request of the mobile terminal, if yes, then the thumbnail picture is sent to the mobile terminal, if no, then a prompting message is returned. In this way, the corresponding thumbnail picture is sent to the mobile terminal only when a user is interested in the text, thereby reducing the amount of data transmission during user browsing process, i.e. the receiving module 12 may specifically include:

a first receiving unit 121 configured to send, when the mobile terminal accesses a microblog, the text to the mobile terminal;

a second receiving unit 122 configured to send, when the mobile terminal requests for accessing the picture corresponding to the text, the thumbnail picture corresponding to the text to the mobile terminal;

a third receiving unit 123 configured to send, when the mobile terminal requests for the original picture, the original picture corresponding to the thumbnail picture to the mobile terminal.

In this embodiment of the present disclosure, the text corresponds to the thumbnail picture and the original picture by means of the corresponding list, which facilitates indexing and modification and can save system overhead during the searching process.

The concepts and principles of the systems in the seventh and eighth embodiments of the present disclosure are the same as those in the methods in the aforementioned fifth and sixth embodiments. Therefore, the parts which are the same as the fifth and sixth embodiments will not be repeated in the seventh and eighth embodiments. At the same time, the aforementioned fifth, sixth, seventh, and eighth embodiments can be used in conjunction with the mobile terminals in the first, second, third and fourth embodiments, which will not be repeated here.

If implemented in the form of software functional units and sold or used as independent products, the integrated units in the embodiments of the present disclosure may be also stored in a computer readable storage medium. Based on such understanding, the technical solutions of the present disclosure (or in other words, parts that contribute to the prior art) can be substantially presented in the form of a software product. The computer software product is stored in a storage medium and includes several instructions for causing a computer (which may a personal computer, a server, or a network device etc.) to execute all or part of the method of each embodiment of the present disclosure. The aforementioned storage medium includes: various mediums which can store program codes, such as U disk, mobile hard disk, Read-Only Memory (ROM), Random Access Memory (RAM), magnetic disk or optical disk and etc.

The above are only preferred embodiments of the present disclosure and not intended to limit the present disclosure, and any modifications, equivalent replacements, improvements and the like within the principle of the present disclosure shall fall within the protection scope of the present disclosure.

What is claimed is:

1. A method for a mobile terminal to access a microblog, comprising:
prestoring an original picture and a text at a server, and correspondingly storing a thumbnail picture corresponding to the original picture;
sending, by the server, the text and the thumbnail picture to the mobile terminal when the mobile terminal sends a request to the server to access the microblog;
sending, by the server, the original picture to the mobile terminal when the mobile terminal sends an original picture downloading request to the server to request for obtaining the original picture corresponding to the thumbnail picture.

2. The method for a mobile terminal to access a microblog according to claim 1, wherein the step of prestoring the original picture and the text at the server, and correspondingly storing the thumbnail picture corresponding to the original picture comprises:
obtaining the original picture, and determining whether or not the number of bytes of the original picture is larger than a preset threshold, zooming out the original picture, when the number of bytes of the original picture is larger than the preset threshold, to generate the thumbnail picture whose number of bytes is smaller than the preset threshold; otherwise taking the original picture as the thumbnail picture;
separately storing the text, the thumbnail picture and the original picture, and generating a corresponding list.

3. The method for a mobile terminal to access a microblog according to claim 1, wherein the step of sending, by the server, the text and the thumbnail picture to the mobile terminal when the mobile terminal sends the request to the server to access the microblog comprises:
sending, by the server, the text to the mobile terminal, when the mobile terminal accesses the microblog;
sending the text and its corresponding thumbnail picture to the mobile terminal, when the mobile terminal requests for accessing the picture corresponding to the text.

4. The method for a mobile terminal to access a microblog according to claim 1, wherein the step of sending, by the server, the text and the thumbnail picture to the mobile terminal when the mobile terminal sends the request to the server to access the microblog comprises:
sending, by the server, the text together with the picture to the mobile terminal, when the mobile terminal accesses the microblog.

5. A system for a mobile terminal to access a microblog, comprising: a server and a mobile terminal; wherein
the server comprises:
a storing module, configured to prestore an original picture and a text, and correspondingly store a thumbnail picture corresponding to the original picture;
a receiving module, configured to send the text and the thumbnail picture to the mobile terminal when receiving a request sent by the mobile terminal, and further configured to send, when the mobile terminal sends an original picture downloading request to request for obtaining the original picture corresponding to the thumbnail picture, the original picture to the mobile terminal;
the mobile terminal comprises:
a request module, configured to send the request to access the microblog to the server, and receive the text and the thumbnail picture sent by the server, and further configured to send the original picture downloading request to the sever to request for obtaining the original picture corresponding to the thumbnail picture and receive the original picture.

6. The system for a mobile terminal to access a microblog according to claim 5, wherein the storing module compries:
an obtaining unit, configured to obtain the original picture, and determine whether or not the number of bytes of the original picture is larger than a preset threshold, zoom out the original picture, when the number of bytes of the original picture is larger than the preset threshold, to generate the thumbnail picture whose number of bytes is smaller than the preset threshold; otherwise, take the original picture as the thumbnail picture;
a corresponding unit, configured to separately store the text, the thumbnail picture and the original picture, and generate a corresponding list.

7. The system for a mobile terminal to access a microblog according to claim 5, wherein the receiving module comprises:
a first receiving unit, configured to send, when the mobile terminal accesses the microblog, the text to the mobile terminal;
a second receiving unit, configured to send, when the mobile terminal requests for accessing the picture corresponding to the text, the thumbnail picture corresponding to the text to the mobile terminal;
a third receiving unit, configured to send, when the mobile terminal requests for the original picture, the original picture corresponding to the thumbnail picture to the mobile terminal.

8. The system for a mobile terminal to access a microblog according to claim 5, wherein the receiving module comprises:
a fourth receiving unit, configured to send, when the mobile terminal accesses the microblog, the text together with the picture to the mobile terminal.

9. A method for sending a picture on a microblog website, comprising:
prestoring an original picture and a text, and correspondingly storing a thumbnail picture corresponding to the original picture;
sending the text and the thumbnail picture to a mobile terminal when a request to access the microblog from the mobile terminal is received;
sending the original picture corresponding to the thumbnail picture to the mobile terminal when an original picture downloading request sent by the mobile terminal according to the thumbnail picture is received.

10. The method for sending a picture on a microblog website according to claim 9, wherein the step of prestoring the original picture and the text, and correspondingly storing the thumbnail picture corresponding to the original picture comprises:
obtaining the original picture, and determining whether or not the number of bytes of the original picture is larger than a preset threshold, zooming out the original picture, when the number of bytes of the original picture is larger than the preset threshold, to generate the thumbnail picture whose number of bytes is smaller than the preset threshold; otherwise, taking the original picture as the thumbnail picture;
separately storing the text, the thumbnail picture and the original picture, and generating a corresponding list.

11. The method for sending a picture on a microblog website according to claim 9, wherein the step of sending the text and the thumbnail picture to the mobile terminal when the request to access the microblog from the mobile terminal is received comprises:
sending the text to the mobile terminal when the request to access the microblog from the mobile terminal is received;
sending the thumbnail picture corresponding to the text to the mobile terminal when a request for obtaining the picture corresponding to the text is received from the mobile terminal.

12. The method for sending a picture on a microblog website according to claim 9, wherein the step of sending the text and the thumbnail picture to the mobile terminal when the request to access the microblog from the mobile terminal is received comprises:
sending the text together with the picture to the mobile terminal when the mobile terminal accesses the microblog.

13. A system for sending a picture on a microblog website, comprising:
a storing module, configured to prestore an original picture and a text, and correspondingly store a thumbnail picture corresponding to the original picture;
a receiving module, configured to send the text and the thumbnail picture to the mobile terminal when receiving a request sent by a mobile terminal, and further configured to send, when the mobile terminal sends an original picture downloading request to request for obtaining the original picture corresponding to the thumbnail picture, the original picture to the mobile terminal.

14. The system for sending a picture on a microblog website according to claim 13, wherein the storing module comprises:
an obtaining unit, configured to obtain the original picture, and determine whether or not the number of bytes of the original picture is larger than a preset threshold, zoom out the original picture, when the number of bytes of the original picture is larger than the preset threshold, to generate the thumbnail picture whose number of bytes is smaller than the preset threshold; otherwise, take the original picture as the thumbnail picture;
a corresponding unit, configured to separately store the text, the thumbnail picture and the original picture, and generate a corresponding list.

15. The system for sending a picture on a microblog website according to claim 13, wherein the receiving module includes:
a first receiving unit, configured to send, when the mobile terminal accesses the microblog, the text to the mobile terminal;
a second receiving unit, configured to send, when the mobile terminal requests for accessing the picture corresponding to the text, the thumbnail picture corresponding to the text to the mobile terminal;
a third receiving unit, configured to send, when the mobile terminal requests for the original picture, the original picture corresponding to the thumbnail picture to the mobile terminal.

16. The system for sending a picture on a microblog website according to claim 13, wherein the receiving module comprises:
a fourth receiving module, configured to send, when the mobile terminal accesses the microblog, the text together with the picture to the mobile terminal.

17. The method for a mobile terminal to access a microblog according to claim 2, wherein the step of sending, by the server, the text and the thumbnail picture to the mobile terminal when the mobile terminal sends the request to the server to access the microblog comprises:
sending, by the server, the text to the mobile terminal, when the mobile terminal accesses the microblog;
sending the text and its corresponding thumbnail picture to the mobile terminal, when the mobile terminal requests for accessing the picture corresponding to the text.

18. The method for a mobile terminal to access a microblog according to claim 2, wherein the step of sending, by the server, the text and the thumbnail picture to the mobile terminal when the mobile terminal sends the request to the server to access the microblog comprises:
sending, by the server, the text together with the picture to the mobile terminal, when the mobile terminal accesses the microblog.

19. The system for a mobile terminal to access a microblog according to claim 6, wherein the receiving module comprises:
a first receiving unit, configured to send, when the mobile terminal accesses the microblog, the text to the mobile terminal;
a second receiving unit, configured to send, when the mobile terminal requests for accessing the picture corresponding to the text, the thumbnail picture corresponding to the text to the mobile terminal;
a third receiving unit, configured to send, when the mobile terminal requests for the original picture, the original picture corresponding to the thumbnail picture to the mobile terminal.

20. The system for a mobile terminal to access a microblog according to claim 6, wherein the receiving module comprises:
a fourth receiving unit, configured to send, when the mobile terminal accesses the microblog, the text together with the picture to the mobile terminal.

21. The method for sending a picture on a microblog website according to claim 10, wherein the step of sending the text and the thumbnail picture to the mobile terminal when the request to access the microblog from the mobile terminal is received comprises:
sending the text to the mobile terminal when the request to access the microblog from the mobile terminal is received;
sending the thumbnail picture corresponding to the text to the mobile terminal when a request for obtaining the picture corresponding to the text is received from the mobile terminal.

22. The method for sending a picture on a microblog website according to claim 10, wherein the step of sending the text and the thumbnail picture to the mobile terminal when the request to access the microblog from the mobile terminal is received comprises:
sending the text together with the picture to the mobile terminal when the mobile terminal accesses the microblog.

23. The system for sending a picture on a microblog website according to claim 14, wherein the receiving module includes:
a first receiving unit, configured to send, when the mobile terminal accesses the microblog, the text to the mobile terminal;
a second receiving unit, configured to send, when the mobile terminal requests for accessing the picture corresponding to the text, the thumbnail picture corresponding to the text to the mobile terminal;
a third receiving unit, configured to send, when the mobile terminal requests for the original picture, the original picture corresponding to the thumbnail picture to the mobile terminal.

24. The system for sending a picture on a microblog website according to claim 14, wherein the receiving module comprises:
a fourth receiving module, configured to send, when the mobile terminal accesses the microblog, the text together with the picture to the mobile terminal.
